(19) United States
(12) Patent Application Publication
(10) Pub. No.: US 2006/0249095 A1
(43) Pub. Date: Nov. 9, 2006

(54) Equestrian jump pole/rail

(76) Inventors: Gary Godges, Coto De Caza, CA (US); Kimberly Godges, Coto De Caza, CA (US)

Correspondence Address: STETINA BRUNDA GARRED & BRUCKER, 75 ENTERPRISE, SUITE 250, ALISO VIEJO, CA, 92656, US

(21) Appl. No.: 11/124,031

(22) Filed: May 6, 2005

(51) Int. Cl. A01K 15/02

(52) U.S. Cl. 119/705

(57) ABSTRACT

An improved equestrian jump pole for use in equestrian sports. The pole comprises an elongate section of tubing, which is preferably formed from a fiberglass material. The tubing is filled with a filler material, which preferably comprises a polymer foam material, such as polyurethane or latex-based foam rubber and the like. The respective ends of the pole further are preferably provided with cap members to prevent dirt, water and the like from infiltrating the interior of the tubing. The poles advantageously can be formed to have an exact length, shape and weight, and are substantially more durable than conventional jumping poles.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention is directed to improved equestrian jump poles, and more particularly, to equestrian jump poles that are substantially more durable and capable of being manufactured to have precise weights and dimensions than prior art equestrian jump poles.

Equestrian sports are well-known in the art. In the equestrian sport of horse jumping, a rider rides a horse along a course having a series of obstacles, namely, jump poles or rails, over which the horse must jump. Typically, such rails comprise elongate wooden jump rails having a generally cylindrical configuration. Alternatively, rails are formed from hollow plastic tubing, and in particular cylindrical polyvinyl chloride (PVC) tubing, which typically has a four inch diameter. Rails are usually formed to have a length of either 10 feet or 12 feet, with 12 feet being utilized for most jumping competitions. Along these lines, rules for equestrian jumping competitions have been established by the International Federation for Equestrian Sports (FEI); however, there are currently no official rules regarding any kind of standardized construction and/or dimensions of jump rails/poles used in jumping competitions.

In light of such ambiguities, most conventional equestrian poles are often not uniformly constructed and suffer from numerous drawbacks. With respect to wooden jumping poles, the same are well known to crack over time. Moreover, to the extent a wooden equestrian jump pole is impacted with enough force, as typically occurs via the impact of a horse hoof or other portion of the horse's body jumping over the rail, the wooden jump rail will break or become irreparably damaged. While attempts have been made in the art to fill cracks and paint such wooden equestrian jump poles, the same are still nonetheless prone to cracking and will eventually break over time. Moreover, by virtue of being fabricated from wood, it is nearly impossible to manufacture wooden rails having uniform dimensions and weight. As such, the use of wooden equestrian jump poles can produce vastly different outcomes insofar as such wooden poles are often times not uniformly dislodged from the jump cups to which the same are mounted. In this respect, by virtue of the dissimilar shape, size and weight of wooden jump rails, there is no uniformity by which such jump rails will either remain in position or otherwise become dislodged from a jump cup, which can vary substantially from pole to pole. As a consequence, one rider impacting a wooden rail may cause the rail to dislodge from the jump cup whereas the same impact from another rider on a different wooden rail may produce an entirely different result. Accordingly, prior art wooden equestrian jump poles can produce capricious results in serving as a barrier over which a horse can jump.

Several drawbacks also exist with respect to the use of hollow PVC tubing for use as equestrian jump poles. As is well-known, hollow PVC tubing can and frequently does break upon impact having sufficient force. Once the PVC tubing breaks, the same is rendered as inoperative for use as an equestrian jump pole. Moreover, by virtue of being hollow in nature, PVC tubing typically tends to be very light and often times can more easily dislodge from a jump cup, as compared to a wooden jump pole positioned within an identical jump cup. As a consequence, equestrian riders will be penalized more readily to the extent a horse fails to execute a jump with greater precision than the same horse would have to make to the extent a wooden jump pole were utilized. Moreover, because there are typically no measures in place to precisely integrate a weight component as part of such PVC tubing, the weight of such tubing is exclusively a factor of the extrusion process by which the PVC tubing is made. Accordingly, significant weight differences can occur through the use of PVC tubing, and, to the extent the same is even capable of being manufactured to possess uniformity in weight from pole to pole, requires consistent manufacturing such that the tubing possesses uniform wall thickness.

As such, there is a tremendous need in the art for an improved equestrian jump pole that is not only more durable than conventional equestrian jump poles, but is further capable of being manufactured such that each equestrian jump pole possesses substantially the same dimensions, and in particular length and shape, as well as weight. There is further a need in the art for such an improved equestrian jump pole that may be readily fabricated using known materials, is of simple construction and of relatively low cost. There is further a need for such improved equestrian jump pole that can be readily utilized in connection with conventional jump cups and the like, and capable of being readily substituted for conventional equestrian jump poles or rails.

### BRIEF SUMMARY OF THE INVENTION

The present invention specifically addresses and alleviates the above-identified deficiencies in the art. In this regard, the present invention is directed to an improved equestrian jump pole/rail that is capable of being manufactured to have precise weights and dimensions, is substantially more durable than prior art jump poles, and can greatly facilitate the ability of equestrian jumping events to be substantially more standardized in nature.

According to a preferred embodiment, the improved equestrian jump pole comprises an elongate section of tubing. In a preferred embodiment, such tubing is fabricated from fiberglass, and more particularly, fiberglass in combination with a suitable resin, which may take any of a variety of resins well-known to those skilled in the art, such as polyester resins and epoxy resins. In a highly preferred embodiment, the fiberglass will consist of fiberglass in combination with an isophtalic resin. Although not preferred, it is contemplated that the tubing may be fabricated from conventional polyvinyl chloride (PVC) tubing well-known to those skilled in the art. The tubing will further preferably be extruded to have a generally cylindrical shape, although other extruded configurations, such as square, rectangular, oval shapes and the like may also be utilized in the practice of the present invention. The section of plastic tubing is preferably filled with a polymer foam material, such as polyurethane, expanded PVC, latex-based foam rubber and any other type of foam material well-known to those skilled in the art. In this regard, by filling the tubing with a polymer foam material enables the improved equestrian jump poles of the present invention to be manufactured to have very precise weights. In certain embodiments, solid rubber or plastic materials may also be utilized to fill the tubing. The improved equestrian jump poles of the present invention are further preferably provided with cap members affixed to each respective end of the equestrian jump pole to thus prevent water, dirt and other debris from infiltrating the interior of the tubing.

Advantageously, the improved equestrian jump poles of the present invention are substantially more durable than conventional equestrian jump poles, such as elongate wooden poles or hollow PVC tubing, that are prone to become irreparably damaged to the extent they become cracked or ruptured as frequently occurs via the impact of horse hooves. The improved equestrian jump poles of the present invention are further capable of being manufactured to have specific weights and dimensions, which can vary drastically with prior art equestrian jump poles, which thus are operative to help standardize equestrian jumping events by ensuring that each equestrian jump pole has a very specific length, weight and shape. To that end, the improved equestrian jump poles of the present invention will further advantageously be adapted for use with conventional jump cups and operative to become dislodged therefrom upon a precise impact of known force from a hoof or other portion of the horse's body indicative of a sub-optimal jump. In this regard, the prior art currently has no method of uniformly manufacturing equestrian jump poles such that the same are always uniform in nature and operative to repeatedly and reliably become dislodged upon an impact having a known prerequisite amount of force. As a consequence, the use of the improved equestrian jump poles of the present invention virtually eliminate all subjectivity with respect to non-uniformly manufactured equestrian jump poles presently in use.

### BRIEF DESCRIPTION OF THE DRAWINGS

These as well as other features of the present invention will become more apparent upon reference to the drawings.

FIG. 1 is a perspective view of an improved equestrian jump pole constructed in accordance with a preferred embodiment of the present invention with the respective ends thereof shown supported by dedicated posts with jump cups attached thereto, the posts and cups being shown in phantom.

FIG. 2 is an exploded view of the improved jump pole of FIG. 1.

FIG. 3 is a cross-sectional view taken along line 3-3 of FIG. 2.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

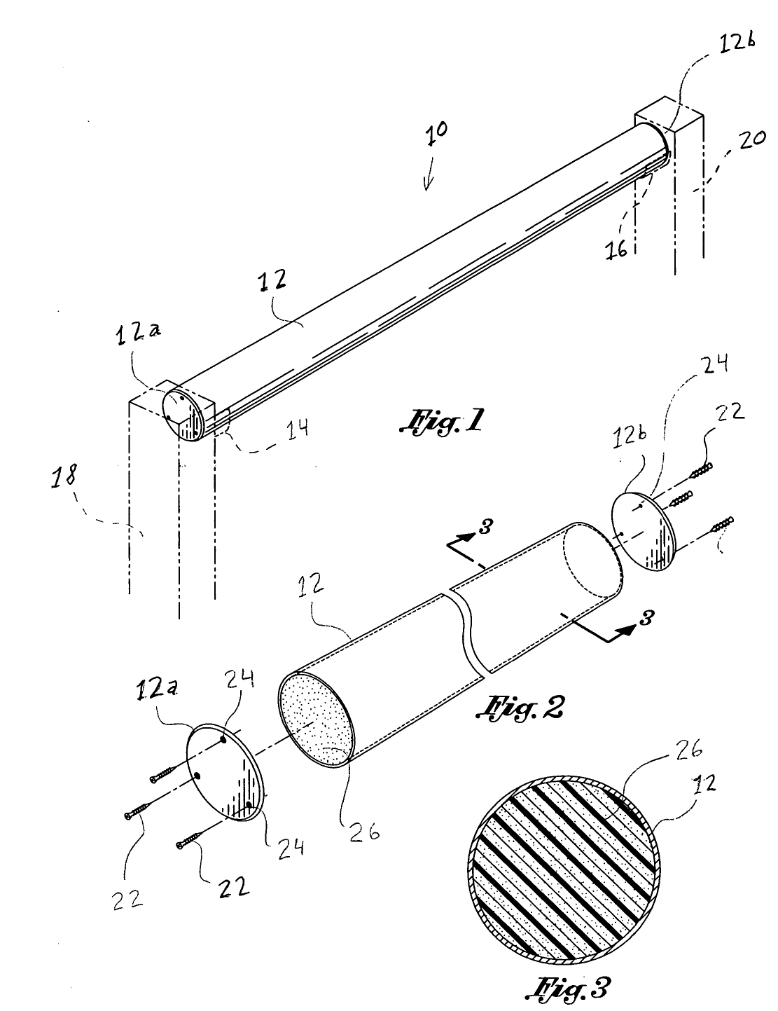

Referring now to the figures, and initially to FIG. 1, there is perspectively illustrated an improved jump pole 10 for use in equestrian sports that provides significant advantages over prior art jump poles. As illustrated, the jump pole 10 comprises an elongate tubular structure 12 having first and second end cap portions 12a, 12b. The respective ends of the tubular structure 12 are configured to rest within conventional jump cups 14, 16, the latter being mounted on dedicated posts or standards 18, 20 as shown in phantom. In this regard, the improved jump pole 10 of the present invention is expressly designed and configured to be utilized with conventional equestrian sporting equipment, such as the conventional jump cups 14, 16 and posts 18, 20 as shown. Along these lines, the improved jump poles of the present invention can be utilized with Applicants' improved jump cups which are the subject of pending U.S. patent application Ser. No. not yet assigned, entitled IMPROVED CUP FOR HOLDING EQUESTRIAN JUMP POLE OR RAIL, not yet filed, the teachings of which are expressly incorporated herein by reference.

With respect to the construction of the improved jump pole 10, there is shown in FIG. 2 the components thereof. As illustrated, the jump pole 10 comprises an elongate section of cylindrical tubing 12, which preferably comprises tubing formed from fiberglass. Along these lines, it is contemplated that the fiberglass, as per conventional practice, will be combined with a suitable resin and formed per conventional fiberglass fabrication techniques. Along these lines, it is contemplated that any of a variety of suitable resins well-known in the art, such as polyester resins and epoxy resins, can be utilized in combination with fiberglass to produce the cylindrical tubing 12 such that the same is generally light weight yet flexible and durable in nature. In a highly preferred embodiment, the cylindrical tubing 12 will be formed from fiberglass in combination with an isophtalic resin.

Although not necessarily preferred, the cylindrical tubing 12 may be formed from a rigid polymer material. For example, the cylindrical tubing 12 may comprise conventional PVC tubing, which is well-known in the art and commercially available. It will be readily understood that other types of materials, including other types of polymers, aluminum tubing and the like may also be utilized in the practice of the present invention.

Preferably, the tubing will be formed to have a length ranging from 6 feet to 18 feet. Consistent with current jumping competitions promulgated by International Equestrian Federation (FEI), the length of such jump pole should be approximately 12 feet, as per conventional jump poles currently in use. As will be appreciated by those skilled in the art, however, the length of cylindrical tubing 12 is not critical, and that such dimension can be selectively chosen to fit a particular application or to conform with whatever applicable equestrian rules may be promulgated over time.

Likewise, it should be understood that although shown as possessing a generally cylindrical configuration, the jump poles of the present invention, by virtue of preferably being formed from a fiberglass resin material, can be formed to have any of a variety of shapes. Along these lines, it should be understood that any and all configurations of the jump poles, whether they be elliptical or rectangular configuration, for example, can be deemed to fall within the scope of the present invention.

As shown in FIGS. 2 and 3, there is disposed within cylindrical body 12 a polymer filler material, which preferably will comprise a foam plastic material 26, such as polyurethane, expanded PVC foam, latex-based foam rubber, polypropylene, polyethylene, polystyrene, and the like. Such foam materials are well-known in the art and easy to fabricate. Such materials can be readily obtained for use in constructing the jump poles of the present invention. Advantageously, such foam materials may be selected such that the same have a known density, which enables the jump poles of the present invention to have very precise weights that can be reliably reproduced. For example, a variety of such foam materials are commercially available from Monmouth Rubber and Plastics Corporation of Long Branch, N.J., which manufactures a wide range of foam products that can range from 1.5 to 55 pounds per cubic foot.

Advantageously, and unlike prior art jump poles, and in particular wooden jump poles, the jump poles of the present invention can be uniformly manufactured so that each jump pole has nearly identical dimensions and weight. As such, to the extent the jump poles of the present invention are utilized, the same will perform consistently from horse rider to horse rider. Prior art jump poles, in contrast, can vary substantially in terms of their ability to become dislodged from the jump cups to which the same are positioned, which in turn can produce unfair results in an equestrian competition whereby riders are judged by their ability to leap over rail-type structures, whether it be post and rails, wall and rails, brush and rails, oxers and/or triple bars. Along these lines, it is contemplated that the improved jump rails of the present invention may be manufactured to have precise dimensions and weights to thus enable the same to serve as standardized equipment to thus provide uniformity to equestrian sport competition.

In addition to functioning as a standardized, readily reproducible piece of equestrian sporting equipment, the improved jump poles of the present invention, by virtue of being fabricated from a flexible, impact resistant fiberglass/resin having a foam-filled core, will possess sufficiently greater durability than hollow PVC pipes. As is well-known, conventional hollow PVC pipe is prone to break after minimal impact force. Once cracked, as frequently occurs by virtue of the nature of equestrian jumping sports, such hollow tubing is ineffective for use as a jump rail. The combination of fiberglass tubing coupled with foam disposed therewithin as provided by the improved jump rail of the present invention, in contrast, provides greater flexibility and structural strength and substantially enhances the ability of the jump rail to withstand cracking or breaking upon impact. As such, the jump rails of the present invention have substantially longer life than either wooden or hollow PVC rails that, as discussed above, are incapable of withstanding multiple impacts frequently encountered in equestrian sports.

In an alternative embodiment, although currently believed not to be preferred, it is contemplated that a reinforcing member, such as a reinforcing bar, such as rebar, may be disposed within the foam core 26 disposed within the tubing 12. Utilizing such a reinforcement bar can greatly enhance the strength of the jump poles of the present invention. The use of such reinforcement bars may not be advantageous, however, insofar as the use thereof can affect the uniformity of the weight of the jump poles, increase the complexity of manufacture of such jump poles, and, perhaps most importantly, diminish the flexibility of the jump poles of the present invention. In this regard, it is important to note that the properties of greater flexibility, as imparted by the preferred fiberglass material, and durability are key features of the poles of the present invention and excessive rigidity and/or inflexibility can cause or aggravate an injury to either the horse and/or rider.

In addition to its cylindrical outer shell and foam interior, the improved jump poles of the present invention are preferably provided with end cap portions 12a, 12b positionable over the respective ends of cylinder 12. Such cap portions 12a, 12b may be fabricated from any of a wide variety of materials known in the art, and preferably may be fabricated from hardened plastic material, such as PVC and the like. The end caps 12a, 12b will further be sufficiently sized and configured to affix to the ends of the cylindrical tubing 12 as shown, and may be secured into position via the use of screws 22 positionable through apertures 24 formed upon the respective end caps 12a, 12b. Providing such end caps advantageously prevents water, dirt and other debris from infiltrating within the interior of the cylindrical tubing 12. The ability to prevent water from entering into the foam interior also helps to maintain the uniformity of the weight of the jump pole to thus enable a uniform weight to be consistently maintained.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention. For example, it should be understood that other inert polymer materials, such as solid rubber and plastic, may be utilized to fill the interior of cylindrical tubing 12. Likewise, materials such as sand, paper and the like may be utilized to fill the interior of tubing 12. In addition, it will be easily understood that the end cap portions 12a, 12b may take any of a variety of structures well-known in the art, and may comprise screw-top cap members threadably interconnectable with the end portions of cylindrical tubing 12.

What is claimed is:

1. An improved jump rail for use in equestrian sports comprising:
a. an elongate section of tubing defining first and second ends;
b. an inert material disposed within the interior of said cylindrical tubing; and
c. first and second end cap portions attachable to respective ones of said ends of said cylindrical tubing.

2. The improved jump rail of claim 1 wherein said inert material comprises a polymer foam material.

3. The improved jump rail of claim 2 wherein said foam material is selected from the group consisting of polyurethane, expanded PVC foam, and latex-based foam rubber, polyethylene, polypropylene, and polystyrene.

4. The improved jump pole of claim 3 wherein said cylindrical tubing is fabricated from fiberglass.

5. The improved jump pole of claim 4 wherein said end cap portions are formed from a polymer material.

6. The improved jump pole of claim 5 wherein each respective one of said end cap members is connectable to a respective one of said ends of said elongate tubing by at least one screw.

7. The improved jump pole of claim 5 wherein said end cap portions are threadably interconnectable with respective ones of said ends of said cylindrical tubing.

8. The improved jump pole of claim 1 wherein said jump rail has a length from between 6 feet to 18 feet.

9. The improved jump pole of claim 8, wherein said jump rail has a length from between 10 feet to 12 feet.

10. The improved jump pole of claim 9, wherein said jump rail has a length of approximately 12 feet.

11. The improved jump pole of claim 4 wherein said fiberglass comprises fiberglass combined with a isophtalic resin.

12. The improved jump pole of claim 4 wherein said fiberglass comprises fiberglass combined with a resin selected from the group consisting of polyester resins and epoxy resins.
